(19) United States
(12) Patent Application Publication
(10) Pub. No.: US 2023/0113236 A1
(43) Pub. Date: Apr. 13, 2023

(54) CRYSTALLINE GRAPHITE AND COMPOSITES FROM MELT-FLOWABLE POLYLIGNIN

(71) Applicant: Comstock IP Holdings LLC, Milton, GA (US)

(72) Inventors: Michael J. Riebel, Mankato, MN (US); David Winsness, Alpharetta, GA (US); Milton J. Riebel, Mankato, MN (US); Kevin Kreisler, Miami, FL (US)

(21) Appl. No.: 17/929,483

(22) Filed: Sep. 2, 2022

Related U.S. Application Data
(60) Provisional application No. 63/240,565, filed on Sep. 3, 2021.

(51) Int. Cl. C08L 97/00; C08K 3/36; C08K 3/02

(52) U.S. Cl. CPC C08L 97/005; C08K 3/36; C08K 3/02; C08K 2003/023

(57) ABSTRACT

A method for making crystalline graphite composite includes the following steps: additives are dry blended with a melt-flowable polylignin to form a blend. The blend is heated to create a melted flowable polylignin with the additives dispersed therein. The melted flowable polylignin is then solidified to a grindable form or to a shaped article of polylignin with dispersed additives, after which sufficient heat is provided to thermoset and carbonize the polylignin with dispersed additives. Additional heat is then provided to graphitize the carbonized polylignin and form a crystalline graphite matrix with uniformly dispersed additives.

### CROSS REFERENCE TO RELATED APPLICATIONS/INCORPORATION BY REFERENCE STATEMENT

This application claims priority to U.S. Ser. No. 63/240,565 filed Sep. 3, 2021, the entire content of which is hereby expressly incorporated herein by reference.

### BACKGROUND

As background, given the growing demand for materials for the production of lithium-ion batteries for automotive and power storage applications, crystalline graphite is a key component in the production of lithium-ion batteries (hereinafter LIB). Although one of the primary uses for graphite is that of lithium-ion batteries, there are other applications that compete for graphite, including the usage in steel as a carbon ingredient and in steel production anodes, in solar heat storage (block graphite) and in high-temperature applications such as brake pads, gaskets, etc. One of the more exciting opportunities is in Vanadium Redox Batteries, which are the large industrial electrical storage batteries for the grid.

Benchmark Mineral Intelligence estimates that the major automakers have committed over US$300 billion to developing EVs and that there are over 100 LIB mega-factories in the pipeline. These factories represent over 2,000 GWh of LIB production capacity, which in turn equates to 800,000 tons of new annual graphite demand by 2023 and 1.4 million tons by 2028. In short, graphite production has to more than double to meet this demand. As a result, the outlook for graphite prices is very bright and the search for secure western sources of supply is critical. Currently, most crystalline graphite for lithium-ion batteries is produced in China.

Graphite is a crystalline form of carbon. By weight, graphite is the largest component in LIBs, and they contain 10-15 times more graphite than lithium. Because of losses in the manufacturing process, it actually takes over 30 times as much graphite to make the batteries as lithium. Graphite for lithium-ion batteries comes from two sources: natural mined or synthetic graphite from the petrochemical industry. The size, structure, and percentage of crystals are three factors that may contribute to lithium battery performance and longevity. Natural graphite currently comes from China, in which specific graphite material is mined and purified. The purification step is not considered environmentally friendly. In addition, natural graphite has a smaller and less crystalline structure than synthetic, and is thus considered a lower grade. But it is typically blended with higher grade synthetics simply for cost reduction. Still, purified natural graphite sells for between $4,000 to over $10,000 per ton based on quality.

Synthetic graphite comes from carbonization of petroleum products such as coal tar or “pitch”. This creates larger unique crystalline structures which provide higher performance and longevity for lithium batteries. The high cost of production is problematic. There is a demand for new and more cost-effective methods for producing crystalline graphite, as well as for carbon negative precursor raw materials.

### SUMMARY OF THE DISCLOSURE

The present disclosure provides methods for making a crystalline graphite composite including the following steps. Additives are blended with a melt-flowable polylignin to form a blend. The blend is heated to create a melted flowable polylignin with the additives dispersed therein. The melted flowable polylignin is then solidified to a grindable form or to a shaped article of polylignin with dispersed additives, after which sufficient heat is provided to thermoset and carbonize the polylignin with dispersed additives. Additional heat is then provided to graphitize the carbonized polylignin and form a crystalline graphite matrix with uniformly dispersed additives.

Because the polylignin is meltable, and is also crystalline upon graphitization, it is possible to uniformly disperse additives within the molten polylignin to produce a unique crystalline graphite with uniformly dispersed additives. Thus, in one embodiment, an electrical material or synthetic graphite application utilizes the crystalline composite made using the above-disclosed method.

In another embodiment, a crystalline graphite composite material includes silica, silicon metal, or both, uniformly distributed within the graphite matrix. In yet another embodiment, a lithium-containing battery includes the crystalline graphite composite material having silica, silicon metal, or both, uniformly distributed within the graphite matrix.

### BRIEF DESCRIPTION OF THE DRAWINGS

FIG. 1 illustrates a process for making crystalline graphite from a hydrophobic polymeric melt flowable “polylignin” in accordance with the present disclosure.

FIG. 2 is a photograph of random melt spun fibers made by heating the polylignin to its melting point in a spinning disk fiber process.

FIGS. 3A and 3B show an XRD comparison of commercial synthetic graphite and graphitized polylignin according to the present disclosure.

FIG. 4A is a photograph of poloylignin after devolatilization at room temperature.

FIG. 4B is a photograph showing the melt flowable characteristics of polylignin at two different temperatures.

FIG. 5A is a photograph of a tiger eye stone.

FIG. 5B is a photograph of a blend of polylignin with a clear PMMA showing a color shift without the addition of any colorant.

FIG. 5C is a photograph of a piece after cooling which shows a highly brilliant metallic copper color and the linear crystal structure of the polylignin.

FIG. 6 is a photograph of biographite crystals after carbonization at 600° C. in accordance with the present disclosure.

FIGS. 7A and 7B are photographs of high strength carbon fibers derived solely from melt spun crystalline polylignin material and carbonized in accordance with the present disclosure.

### DETAILED DESCRIPTION

While the following terms are believed to be well understood by one of ordinary skill in the art, the following definitions are set forth to facilitate explanation of the presently disclosed subject matter.

Following long-standing patent law convention, the terms “a”, “an”, and “the” refer to “one or more” when used in this application, including the claims. Thus, for example, reference to “a monolignol-acrylate” includes a plurality or mixture of fibers, plastics, materials and so forth.

Unless otherwise indicated, all numbers expressing quantities of size (e.g., length, width, diameter, thickness), volume, mass, force, strain, stress, time, temperature, or other conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

The term “lignocellulosic” refers to a composition comprising both lignin and cellulose. In some embodiments, lignocellulosic material can comprise hemicellulose, a polysaccharide which can comprise saccharide monomers other than glucose. Lignocellulosic materials can also comprise additional minor components, such as non-structural phenolic compounds, fatty acids, glycerides, waxes, terpenes, and terpenoids.

The term “Lignin” is a polyphenolic material comprised of phenyl propane units linked by ether and carbon-carbon bonds. Lignins can be highly branched and can also be crosslinked. Lignins can have structural variation that depends, at least in part, on the plant source involved.

The Term Monolignol—Lignols and Monolignols are phytochemicals acting as source materials for biosynthesis of both lignans and lignin. The starting material for production of monolignols is the amino acid phenylalanine. The first reactions in the biosynthesis are shared with the phenylpropanoid pathway, and monolignols are considered to be a part of this group of compounds. Three monolignols predominate: coniferyl alcohol, sinapyl alcohol, and paracoumaryl alcohol. The ratio of these components varies with plant species.

The monolignol polymeric is the resulting monolignols which are further reacted with “self-generated” biochemicals from the hybrid organosolv/reactive phase separation process as to create a controlled melt flow, high flowability, highly reactive biopolymer. Thus, the material is a hybrid blend of reacted monolignols with these various self-generated biochemical(s) which include furan, furfural, esters, and acetic acid.

The term polylignin generally relates to a hydrophobic polymeric lignin and refers to the fractionated hydrophobic crystalline monolignols which were produced in a hybrid organosolv/reactive phase separation in which self-generated biochemical and hydrophobic lignin fraction creates a highly linear crystalline structure.

The term hydro lignin is the amorphous insoluble fraction of fractionated lignin.

The term aqua lignin is a water-soluble fraction of fractionated lignin.

The term monolignol is a fractioned part of native lignin that also can include molecular lignin fragments.

The presently disclosed subject matter will now be described more fully hereinafter with reference to the accompanying Examples and Drawings, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

Throughout the specification and claims, a given chemical formula or name shall encompass all optical and stereoisomers, as well as racemic mixtures where such isomers and mixtures exist

Disclosed herein is a biobased crystalline graphite material, sometimes referred to as biographite, that can be used in lithium-ion batteries and other synthetic or mined graphite applications. The biographite is derived from the carbonization of a novel fractionated and modified monolignol polymer which comprises a high carbon content. This creates large crystals and a highly crystalline structure in the carbonized biographite.

The present disclosure provides for a green environmentally friendly, rapid renewable bio graphite for usage in lithium batteries and other crystalline graphite applications. The present disclosure also starts with a carbon negative precursor raw material derived from a rapidly renewable resource and a new cellulosic biorefining process.

The present disclosure allows for new processes of biorefining of biomass including fractionation and modification of specific parts of the lignin molecule now having the ability to be carbonized into a crystalline graphite as outlined in the present disclosure. More so, the present disclosure provides for a pathway and methods to create new “hybrid” graphite materials in which the precursor material can be in liquid form by melting or in a liquid state in which various functional additives can be introduced homogeneously prior to carbonization/pyrolysis processes to create new forms of carbon structures and functionality in the biographite materials. In one aspect, the disclosure describes the creation of a biobased crystalline graphite material derived from a co-product of cellulosic biofuels process that can be used in lithium-ion battery applications, the steel industry and in other crystalline graphite applications.

In another aspect, the disclosure describes the creation of a biographite wherein the process is environmentally friendly and starts with a carbon negative raw material.

In yet another aspect, the disclosure describes a process that can be further powered by solar, wind, syngas, or biofuel electrical/heat generation to create a carbon neutral or even carbon negative biographite.

In yet another aspect, the disclosure describes the processing of biomass using a hybrid organosolv/reactive phase separation process wherein the lignin fraction of biomass is further fractionated and modified into three specific monolignol or fractured lignin groups of hydrophobic polymeric polylignin, insoluble hydro lignin, and water-soluble aqua lignin in which the polylignin is the preferred feedstock for the production of biographite.

In yet another aspect, the disclosure describes the creation of a monolignol precursor in which the lignin from biomass is fractionated and “ring opened” providing a more linear structure in the resulting polylignin precursor material.

In yet another aspect, the disclosure describes the further purification of the polymeric hydrophobic polylignin to remove any amorphous materials or impurities leaving a crystalline structure material. In yet another aspect, the disclosure describes the polylignin being melt flowable or having the ability to be in a liquid phase in which various functional additives are integrated prior to carbonization/pyrolysis that can modify the carbon structure and end performance of the biographite.

In yet another aspect, the disclosure describes the carbonization of the polylignin to create crystalline graphite in which carbonization can be done by conventional heat, plasma, microwave, or combination thereof in an inert atmosphere.

In yet another aspect, the disclosure describes the polylignin being first formed into a shape based on its thermoplastic melt flowable characteristic prior to thermosetting within the first phases of oxidizing or carbonization.

In yet another aspect, the disclosure describes the polylignin being melt blended with various functional additives, fillers, additives, metals, metal oxides or silica, silicons, or silicon oxides prior to carbonization.

In yet another aspect, the disclosure describes integration of the ability to remove syngas during carbonization/pyrolysis which can be used as a vapor phase fuel or converted into liquid renewable fuels providing for a decarbonization pathway and carbon negative biographite product.

In prior art, there have been efforts to produce a crystalline graphite carbon from biomass. Unmodified biomass typically provides for a high degree of amorphous carbon vs. the graphite crystalline carbon required for energy storage applications. In some art, the usage of a catalyst during graphitization helps reduce activation energy during the conversion process. Catalytic graphitization is usually carried by aid of transition metal such as V, Zr, Pt, Ti, Al, Mn, Fe, Co, or Ni or metallic compound Cr₂O, MnO₂, MnO₃, or Fe₃O₄. The issue with working with biomass is that it comprises lignin which is an amorphous material within the biomass and yields amorphous carbon when carbonized. Lithium-ion batteries require pure high percentage of crystalline carbon or graphite for long life and high energy storage.

Native lignin or lignin from a paper mill (Kraft lignin) also has been evaluated for carbonization. Lignin starts as highly amorphous molecular structure and retains that amorphous structure during carbonization with very low amount of crystalline formation. A publication from North Carolina State University (NCSU), “Comparison of four technical lignin's as a resource for electrically conductive carbon particles,” evaluated kraft lignin, soda lignin, lignosulfonate, and standard organosolv lignin by carbonization process and evaluating the carbon. Crystalline carbon of high purity is required for usage in lithium-ion batteries. NCSU found that all of the lignins tested were highly amorphous and exhibited a highly “disordered” structure and very poor performance in terms of electrical conductivity. Again, this did not produce acceptable crystalline graphite.

In order to attempt to improve this problem, U.S. Application Publication 2014/0038034, “Lignin-based active anode materials synthesized from low-cost renewable resources”, by UT-Battelle teaches that lignin can first be processed into a fiber, then carbonized in a poor-quality carbon fiber and the fiber can be used as an anode. This is problematic given that the starting lignin is highly amorphous and also does not have a polymeric melt flow characteristic. This requires that the lignin is first dissolved or heavily modified. This also creates problems during carbonization wherein the material still retains a degree of amorphous material and can be porous, which may lead to micro cracking of the material during charging and discharging. This art also requires chemical modification or a catalyst.

U.S. Pat. No. 10,011,492, “Carbon products derived from lignin/carbon residue”, teaches making a hard carbon using a blend of conventional lignin and coke from a petrochemical process, which is then carbonized. In this art, the lignin is a simple filler that still creates an amorphous grade of carbon.

In other prior art, work has been done to attempt to utilize lignin as a raw material for the creation of carbon fibers. Various patents teach starting with a standard lignin and dissolving the lignin in an alcohol or solvent. The material is spun into fibers and carbonized. Within all of this art, we cannot find any lignin-based carbon fiber with a consistent tensile strength closer to 400 MPa on average. Normal polyacrylonitrile (PAN) petroleum-based carbon fibers typically have tensile strength over 3,000 MPa given their highly crystalline linear structure wherein the lignin art still creates a highly amorphous carbon structure with less strength.

Thus, the amorphous nature of lignin and other biobased materials has created problems not allowing for a good pathway to create crystalline graphite from renewable resources.

Also, the requirement for longer lasting higher energy output lithium batteries requires large crystals and a highly crystalline smooth structure that has not yet been achieved in carbonization of biomass. This crystalline structure is beneficial for lithium-ion batteries. The structure is beneficial for the ion storage and transfer to create and store power.

There is a demand for a renewable source of premium highly crystalline graphite that also can be lower in cost and sourced within the United States. In addition, there is a demand for a process that is environmentally friendly and does not create massive pollution or large volumes of CO₂ and greenhouse gases as mined graphite or synthetic petroleum-based graphite.

It is highly desirable to create crystalline graphite with a starting raw material that is carbon negative as compared to the coal/coke used for synthetic and the mining/purification process for mined graphite that both use massive energy, creates pollution and clearly is not a starting carbon neutral material.

Graphite is a component of lithium-ion batteries (“LIB”). Graphite is a crystalline form of carbon. By weight, graphite is the largest component in LIBs, and LIBs contain 10-15 times more graphite than lithium. Because of losses in the manufacturing process, it actually takes over 30 times as much graphite to make the batteries as lithium.

Crystalline graphite may be preferred for long-life lithium-ion batteries. This is why many attempts have fallen short wherein other natural materials have been carbonized into graphite. Natural lignin by itself or still within various biomass is amorphous by nature, thus simply carbonizing an amorphous material yields an amorphous carbon. Crystalline graphite is required for applications such as lithium batteries for both the storage of the ions relating to energy charge and discharge capacity and also for long life and higher energy storage. Common amorphous graphite is highly “disordered”—and thus, problematic—for energy storage and long lifetime, making it ill-suited to meet the growing demand for lithium-ion batteries in automotive applications. Thus, the present disclosure starts by the process to create a high carbon, highly crystalline biobased starting material produced by carbon neutral processing methods.

Graphite for lithium-ion batteries comes from two sources: natural mined or synthetic graphite from the petrochemical industry. The size, structure, and percentage of crystals are three factors that may contribute to lithium battery performance and longevity.

Natural graphite currently comes from China in which specific graphite material is mined and then purified. The purification step is not environmentally friendly in many ways. In addition, natural graphite has smaller and less crystalline structure than synthetic thus considered a lower grade, but typically blended with higher grade synthetics simply for cost reduction.

Synthetic graphite comes from carbonization of petroleum products such as coal tar or “pitch”. This creates larger unique crystalline structures that provides higher performance and longevity for lithium batteries. A problem is the high cost of production.

Another issue relating to mined or synthetic crystalline graphite for usage in lithium-ion batteries relates to production and location of production. Currently most all crystalline forms of graphite for lithium batteries comes from China. The process of producing either mined or synthetic graphite is environmentally unfriendly, requires tremendous amounts of energy from coal fired power plants, creates large amounts of pollution due to the purification process and other problematic concerns. Secondly, there is concern over the reliance of China to supply the global demand for crystalline graphite for energy storage devices. Currently, there is no production in the United States.

Many research groups have searched for a more environmentally friendly solution such as biomass or carbon containing lignin portion of biomass. Lignin, either isolated or still within the biomass is all amorphous structures which when carbonized retains its amorphous structure and does not produce crystalline graphite required for lithium-ion batteries. Although cellulose is a crystalline structure, it is very low carbon content typically less than 40%.

Lignin is part of the carbon storage system within biomass and typically can have over 60% carbon content, but Lignin's amorphous structure makes it limited. This amorphous structure also shows that lignin is not meltable nor has a melting point below its thermal degradation point.

In one aspect, the present disclosure describes the creation of a renewable resource raw material for manufacture of crystalline graphite. The raw material comes from fractionated and modified portions of lignin and is hydrophobic, has melt flow characteristic and generally crystalline in molecular structure prior to carbonization. In addition, the presently described material is carbon-neutral and can be produced at a lower cost in the US than current crystalline graphite products from China.

In another aspect, the present disclosure relates to biomass. In some embodiments, biomass is lignocellulosic feedstock material and is selected from the group including, but not limited to, herbaceous material, solvent extracted materials, agricultural residues, forestry residues, municipal solid wastes, wastepaper, pulp and paper mill residues, biorefinery residues, residues from fuel production, or a combination thereof. In some embodiments, lignocellulosic feedstock material is selected from the group including, but not limited to, hardwood, softwood, an annual plant, or combinations thereof. In some embodiments, the lignocellulosic feedstock can be provided in an appropriate size, e.g., as chips, particles, micro particles as desired. In other embodiments, the biomass can be conventional lignin such as kraft lignin or conventional organosolv lignin. The present disclosure may also include various standard forms of lignin including, but not limited to kraft lignin, soda lignin, lignosulfonate and conventional organosolv lignin. In addition, the present disclosure may use the residual material from hemp processing from CBD oil production wherein hemp can provide a unique form of biomass with additional benefits relating to the CBD extractive product.

The present disclosure utilizes a hybrid organosolv/reactive phase separation process to fractionate, separate and “molecularly modify” specific components of the biomass. Biomass comprises cellulose, hemicellulose, and lignin. Cellulose is a highly crystalline material, but low in carbon content. Lignin is an amorphous material which occurs naturally and are chemically bonded to the cellulose are generally designated as “proto-lignins”. These proto-lignins are complex substances having a non-uniform polymer structure made of repeating elements such as cumaryl alcohol, sinapyl alcohol, and coniferyl alcohol. Lignols are considered to be a part of this group of compounds. Three monolignols predominate: coniferyl alcohol, sinapyl alcohol, and paracoumaryl alcohol.

Lignin can be carbonized into a graphite type of material, but this type of graphite is not crystalline. Rather, this type of graphite is amorphous, similar to the lead found in pencils, and not useful for lithium-ion batteries and other applications that require pure highly crystalline graphite. Lignin in its native form and as a by-product of paper processing (kraft lignin) are all starting as amorphous materials, thus when carbonized they remain as amorphous carbon.

The present disclosure first takes biomass and fractionates/separates the three basic components of biomass: cellulose, hemicellulose, and lignin by means of a hybrid organosolv/reactive phase separation process. The hybrid organosolv process dissolves the hemicellulose and converts a portion of this fraction into self-generated biochemicals. These biochemicals are great lignin dissolving solvents and have the ability to further modify lignin. Such biochemical derived from dissolving and reacting the hemicellulose fraction are furfural, organic furans, HMF, butyl acetate and butyl esters. Many of these biochemical solvents are hydrophobic. The hybrid organosolv process utilizes a blend of butanol, self-generated biosolvents/biochemicals, water and the biomass that is subjected to heat and pressure for a period of time to create these reactions and fractionate the three primary materials.

U.S. Pat. No. 9,365,525 (System and method for extraction of chemicals from lignocellulosic materials) and U.S. Pat. No. 9,382,283 (Oxygen assisted organosolv process, system, and method for delignification of lignocellulosic materials and lignin recovery) herein incorporated by reference in its entirety provides for a hybrid organosolv/reactive phase separation process that creates a novel form of meltable lignin herein incorporated by reference in its entirety.

US Provisional Application “CATALYST FREE ORGANOSOLV PROCESS, SYSTEM AND METHOD FOR FRACTIONATION OF LIGNOCELLULOSIC MATERIALS AND BIOPRODUCTS”, teaches a hybrid organosolv/reactive phase separation process using a “catalyst free” system for cellulosic biorefining that provides a meltable lignin-based material herein incorporated by reference in its entirety.

Although the previous patent included within this the present disclosure teaches of a meltable lignin, the meltable lignin has a very low melting point, no melt strength, and further comprises a high percentage of impurities that are problematic for creating a highly crystalline structure with large crystals.

RIEBEL/WINSNESS Patent Application METHOD FOR SEPARATING AND RECOVERING LIGNIN and MELTABLE FLOWABLE BIOLIGNIN POLYMERS, Publication 2022/0081517, and parent application Ser. No. 16/119,030 are incorporated herein by reference in their entirety. They teach further processing to create a melt flowable biopolymeric lignin from black liquor and the above meltable lignin to create more melt stable hybrid polymeric monolignol biopolymers with higher melting points, higher purity and improved viscosity sufficient for extrusion of fibers in part based on devolatilization processes of meltable lignin herein incorporated by reference in its entirety.

The above technologies were primarily based on the ability to fractionate the biomass as to provide for a cleaner for cellulose with less remaining inhibitors of lignin and hemicellulose for the cellulose to be used in pulp and more so in further conversion of cellulose into sugars, then cellulosic biofuels. This clearly provides for advantages, including higher efficiencies, higher yield, and lower cost than other cellulosic biofuels art. The remaining lignin is melt flowable and some residual lignin remains in other fractions of the outputs.

In one aspect, the present disclosure describes the hybrid organosolv process actually fractures or depolymerizes the lignin and yields three distinct “monolignol” or molecular fragment materials which can be isolated and separated in the reactive phase separation. This can be done by batch processing or by subcritical or supercritical continuous processing. By using subcritical or supercritical process, the time for reactions and the time for cooling are greatly reduced further improving the yield and efficiency of this process.

The hybrid organosolv process starts with butanol and water with the optional addition of acid for the first run. With the first process cycle of heat and pressure, the hemicellulose fraction is dissolved and converted into self-generated biochemicals. The major portions of these biochemicals are hydrophobic and end in the hydrophobic organic phase that then are separated and removed. The future continuous cycles of the process recycle the hydrophobic lignin dissolving biochemicals with the addition of water. From this point on, the self-generated hydrophobic lignin dissolving biochemicals can be recycled in many upcoming cycles being more efficient and producing better quality materials.

The lignin is fractionated into three specific fractions all having different molecular structures. In one of these structures, we react with self-generated biochemicals from the hemicellulose fraction which yields a crystalline polymeric hydrophobic material what we call “Polylignin”. Polylignin has a melting point and melt flow characteristics similar to that of a conventional thermoplastic and additionally can be re-melted or reprocessed many times. At higher temperatures, the polylignin can thermoset, thereby locking in a crystalline structure. The crystalline structure can then be carbonized to create crystalline graphite materials.

We believe within this process that this hydrophobic fraction of the lignin or monolignol may be molecularly modified or possibly ring opened thus creating a novel carbon structure based on the presents of various organic furan biochemicals produced from hemicellulose within this process and that this fraction is not exposed to water. This provides for a polylignin fraction that is melt flowable, hydrophobic and a crystalline structure.

These new linear forms of modified linear polymeric lignin fragments have been dissolved within the organic layer or hydrophobic layer within phase separation. By removal of the hydrophobic biosolvents within the organic layer, the linear monolignol fragments “stack” in an ordered form and become solid at room temperature but has a specific melt flow temperature and viscosity when heated. Thus, the linear polymeric lignin fragments (Polylignin) comprise a linear polymer molecular structure. The polylignin is the preferred precursor for the process of making biographite with a crystalline structure.

The hydrophobic modified monolignol fragments already dissolved within the hydrophobic organic layer can include various additives such as various molecular modifiers, nucleating agents, or functional filler materials that further can modify the molecular structure of the polylignin after biosolvents are removed and further transfer to unique molecular structures after carbonization or pyrolysis processes.

We also believe that the “polylignin” hydrophobic melt flowable material may be a reaction between hydrophobic lignin, organic furans and the self-generated biochemicals as to create a novel crystalline structure that allowed for melting and with the ability to create new forms of crystalline carbon materials.

For the present disclosure, polymeric melt flowable “polylignin” is used as a feed material for making crystalline graphite. Polylignin is a monolignol or lignin fraction that was reacted and still comprises a small percentage of the self-generated biosolvent which comprises hydrophobic lignin dissolving agents such as butanol, furfural, butyl acetate and acetic acid. To our surprise, this apparently restructures the monolignol or hydrophobic lignin fragments into a new form of carbon structure that is more crystalline, highly polar and has other novel properties.

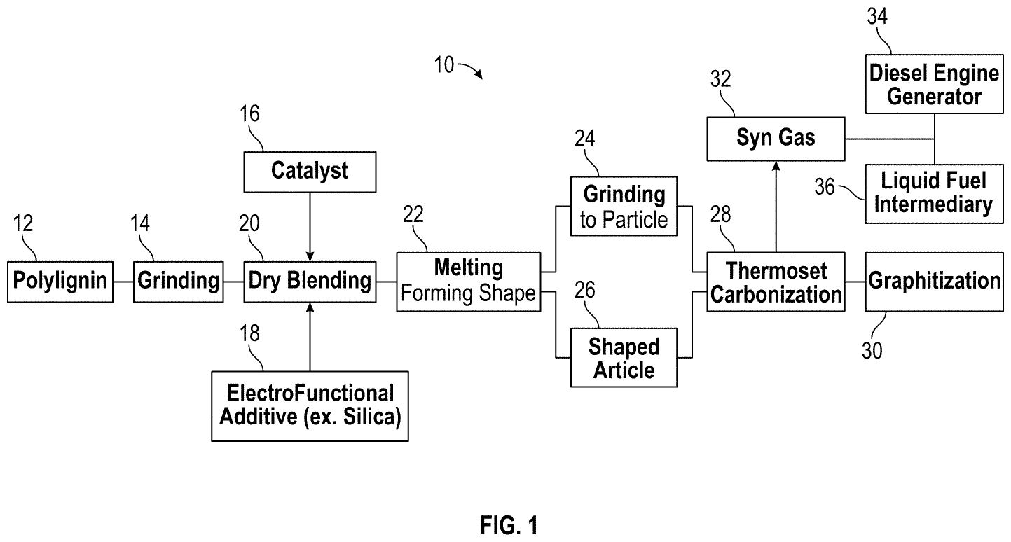

As shown in FIG. 1, we developed a process 10 for making crystalline graphite from polylignin 12. In one embodiment, the polylignin 12 can first be ground 14, and additives such as catalyst 16 and/or functional additives 18 can be dry blended 20 with the particulate melt-flowable polylignin to form a particulate blend. The particulate blend is heated to melting 22 creating a melted flowable polylignin with the additives dispersed therein. The melted flowable polylignin is then solidified to a grindable form which is ground 24, or is formed into a shaped article 26 of polylignin, each having the additives 16 and/or 18 dispersed therein. Sufficient heat is provided to thermoset and carbonize 28 the polylignin with the dispersed additives 16 and/or 18. Additional heat can then be provided to graphitize 30 the carbonized polylignin and form a crystalline graphite matrix with uniformly dispersed additives. This product is unique in that previous attempts to uniformly disperse additives into crystalline graphite have not had the advantage of using a melt flowable starting material in which to disperse the additives, and thus it has not previously been possible to make such a product. Advantageously, syngas 32 released during carbonization 28 can be converted into a vapor phase fuel that can run a slightly modified diesel engine electrical generator 34, or the syngas 32 can be further converted into a renewable liquid fuel 36 for usage or sale.

In another embodiment, additives such as catalyst 16 and/or functional additives 18 can be added to the polylignin 12 while the polylignin 12 is in a liquid form.

Softwood Vs Hardwood Lignin to Polylignin

Different biomass raw material inputs can clearly have an effect on the crystalline biographite and its structure. Polylignin produced by using softwood or a hardwood biomass as a starting material can create the characteristics shown below but concentrations can vary with biomass type and process conditions:

| | Softwood | Hardwood |
|---|---|---|
| Carbon % | 70.59 | 63.8 |
| Hydrogen % | 5.3 | 5 |
| Nitrogen % | 0.24 | 0.29 |
| Sulfur % | 0.03 | 0.09 |
| Oxygen % | 23.7 | 30.7 |

Although the preferred embodiment of the present disclosure starts with biomass from wood such as softwood and hardwoods, other forms of biomass are included such as rapid growth willow and hybrid popular, bamboo, grasses, and agricultural residues each can have an effect on the final crystalline biographite structure.

Within the hybrid organosolv/reactive phase separation processing of biomass the hemicellulose is converted to self-generated biochemical. The cellulose free from the hemicellulose and lignin is removed for further enzymatic processing into biofuel (cellulosic ethanol). The lignin within this reaction and biochemical is “fractured” into three specific lignin molecular fragments or monolignol materials. The three fractions are separated in the reactive phase separation process into hydrolignin (insoluble fragments), aqua lignin (water soluble fragments) and a polymeric melt flowable highly hydrophobic POLYLIGNIN monolignol biopolymer.

Polylignin

In nature, the resilient lignin polymer helps provide the scaffolding for plants, reinforcing slender cellulosic fibers—the primary raw ingredient of cellulosic ethanol—and serving as a protective barrier against disease and predators. Lignin's protective characteristics persist during biofuel processing, where it becomes a major hindrance, surviving expensive pretreatments designed to remove it and blocking enzymes from breaking down cellulose into simple sugars for fermentation into bioethanol. More so, not only does lignin bind to cellulose in the preferred locations sought by enzymes, but lignin also attracts and occupies the cellulose-binding domain of the enzymes themselves.

During pretreatment, acid, water, and heat work to remove non-cellulosic biomass from plant material. Lignin, however, sticks around, clustering into aggregates around the cellulose and impeding enzymes from reaching cellulose.

The present disclosure provides a solution and also provides for a method that fractionates, separations and modifies the native lignin into three unique monolignol fractions. The hydrophobic fraction is dissolved within a hydrophobic blend or organic furans and self-generated biochemical solvents that further change the molecular structure of this specific hydrophobic monolignol fraction. The inventors believe that the presence of the organic furans in a hydrophobic biochemical solvent binds and dissolves this specific monolignol fragment, making the balance of aqueous and insoluble lignin easy to separate and remove. We also believe that in the presence of the organic furans within the hydrophobic biochemical solvent that is self-generated within this process provides for this hydrophobic lignin fraction to open into long coils or more linear structures.

In most aqueous-based pretreatments, lignin is not removed entirely from biomass; instead, lignin and pseudo-lignin (material generated by the combination of lignin and hemi-cellulose degradation products aggregate onto the cellulose surface, blocking enzymatic access to cellulose and binding unproductively to the enzymes an undesirable behavior for the production of biofuels. This coalescence of lignin in water can be understood in a general framework of the “quality” of a solvent relative to a polymer. Three classes of solvent can be considered. In a “bad” solvent, such as water, polymer-polymer interactions are favored, and the polymer collapses to “globular” conformations in which monomers are tightly packed. Furthermore, bad solvent conditions lead to the formation of multi-polymer aggregates that, for lignin, pose a major barrier to cellulose hydrolysis in pretreated biomass.

Conventional lignin in an aqueous solution at temperatures below the glass transition point, the polymer has a native state corresponding to a “crumpled globule” and highly disordered amorphous state.

Within the primary biorefining process that integrates both a water and butanol blended with various self-generated biochemicals such as butyl acetate, butyl esters, furfural, various organic furans, acetic acid and other biochemicals. This provides for a two-phase system wherein a portion of butanol and most of the self-generated biochemicals are hydrophobic. At higher temperatures of processing the water and hydrophobic biochemicals are immiscible, but at room temperature they quickly separate into an organic hydrophobic layer and an aqueous water-soluble layer.

The presence of organic furans and other of these biochemicals is relevant to the present disclosure given that organic furans and other of these biochemicals can selectively fractionate the lignin into three specific molecular fragments from the lignin: water soluble aqua monolignols, insoluble hydro monolignols, and hydrophobic “polylignin”.

The polylignin fraction is novel given the polylignin fraction melts and can be re-melted similar to a conventional thermoplastic. In addition, the process has converted the molecular shape of this hydrophobic fraction into a more linear polymeric structure. The dissolved and molecularly modified polylignin within the organic layer has comprises no water, thus once the biochemical solvents are removed from this layer leaving the polylignin, the linear molecular forms seem to create a crystalline linear structure which is solid at room temperature.

We have found that the self-generated organic furans in the presence of the hydrophobic biochemicals provides for a means to fractionate a specific hydrophobic portion of the lignin and convert this hydrophobic lignin fragment into a novel linear crystalline or semi-crystalline structure. This is accomplished by not allowing the hydrophobic modified lignin fragment to see water that can recoil the molecular fragment, but keep it dissolved within the hydrophobic biochemical solvent blend that comprises furans.

The unique blend of organic furans with the self-generated biochemical solvent provides for a local solvent for lignin removing only the hydrophobic molecular portion of lignin and limits lignin-lignin hydrogen bonding that can happen in presence of water.

In another embodiment of the present disclosure, a polylignin with linear polymeric structure is produced using a blend of butanol, self-generated biosolvents, and water in which phase separation separates and removes the polylignin fraction of lignin and molecularly modifies it into a linear polymer as a precursor of the present disclosure. The present disclosure also includes various pathways to create a polylignin precursor from biomass or lignin containing materials in which we provide a blend of organic furans, a hydrophobic solvent, and water as to allow for the fractionation, separation, and removal of specific lignin fragments.

Modification in Liquid Form

The linear hydrophobic fraction of the lignin is dissolved in the organic furan/biochemical solvent blend. In this dissolved, but modified phase, we then have the ability to add various functional additives such as nucleating agents, functional fillers, or modification agents so that once the biosolvent has been removed, we have the ability to modify the final material and its structure. After biosolvents are removed a new carbon structure is formed and the modified linear hydrophobic lignin fragments become a solid at room temperature.

The modified structure “polylignin” then can be ran through a series of carbonization and/or pyrolysis steps to create novel graphite structures and unique graphite products.

More so, this high carbon biopolymer, polylignin, has the ability to melt, re-melt and have a melt flow similar to that of conventional petroleum thermoplastics. It is highly polar and has a more crystalline structure that allows it to be processed similar to crystalline thermoplastics. In a molten state the material becomes extremely sticky within a specific temperature range and decreases viscosity at higher plastic processing temperatures. To our surprise, as we continue to increase temperature beyond 400° F. for an extended period of time, we see the material actually thermoset in a non-meltable form.

The present disclosure further takes the above methods to produce a crystalline polylignin material and integrates a purification process to further improve the degree of crystallization and crystal sizes. The polylignin from the hybrid organosolv/reactive phase separation process may comprise residual materials and sugars of low molecular weight. By means of grinding, washing and other purification processes, we can purify the polylignin prior to carbonization which further improves the crystallinity and quality of the material for biographite production.

By starting with polylignin, a high carbon content produce from a carbon neutral process which is highly crystalline with the ability to melt flow, when carbonized, it produces a crystalline structure with large crystal sizes. To our surprise, crystal sizes were larger and better than mined purified graphite and actually more surprising larger crystal than synthetic graphite.

Although the preferred embodiment uses fractionated and modified lignin fragments or monolignols using a hybrid organosolv/reactive phase separation process as incorporated above, the embodiment includes other pathways to create a melt flowable hydrophobic lignin-based material that can also be carbonized into a biobased graphite material.

Within the embodiment, lignin can come from other organosolv or even kraft paper mill sources wherein the lignin is processed using heat and pressure using a blend of water and hydrophobic lignin solvents to fractionate the lignin and separate out a form of polylignin. The preferred embodiment also has other advantages including that other products from this hybrid organosolv/reactive phase separation process for woody biomass is highly efficient in the production of sugars that further can be processed into cellulosic ethanol biofuel. Thus, providing good economies and creates the opportunity for carbon-neutral biofuels and carbon-neutral polylignin for the creation of biographite.

The resulting polymeric melt flowable monolignols can be liquid or solid form at room temperature but have a thermoplastic characteristic with the ability to have a melt flow and remelting properties of a conventional thermoplastic. This material is called a monolignol biopolymer (MLB) or an alternative form of “polylignin”.

In a solid form, the polylignin is easily ground into chucks, particles, or powders using standard grinding equipment and methods. The ground material then can be run through various purification processes which is simply washing with water or a water alcohol blend or with other means such as devolatilization using heat and shear or combinations thereof to remove any residual sugars or other impurities within the material, but still retain its thermoplastic melt flow properties.

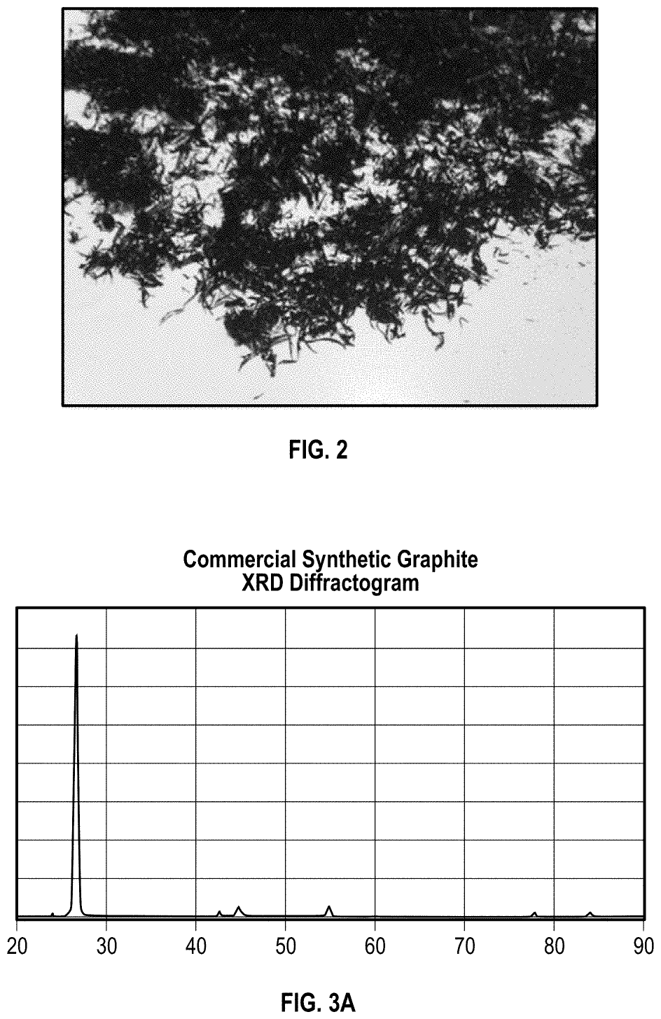

In early testing of the polylignin, we saw differences as compared to conventional lignins in compounding with various other polymers and plastics. The blending of polylignin with a lactide, both hard brittle materials, to our surprise provided for a highly elastic thermoplastic elastomer. This shows that our polylignin has a unique linear crystalline structure. Further testing also showed that the polylignin can be easily melt spun into fibers without the addition of an alcohol or dissolving agent. See FIG. 2.

This led to further testing wherein the fibers were then carbonized to evaluate the potential application for biobased carbon fiber. Significant work has been done to attempt to make carbon fibers from lignin, but they all have been limited due to the amorphous structure of the starting lignin. Thus, attempts made to create carbon fiber from lignin have yielded very low tensile strength numbers around 300-400 MPa wherein synthetic carbon fibers are approximately between 2000-5000 MPa tensile strengths given that synthetic carbon fibers start with a highly crystalline large molecular weight PAN polymer.

Within further testing of our polylignin fibers after carbonization, we were surprised that we saw an increase in tensile strength over 1,000 and after additional modification hit over 1,200 MPa tensile strengths. Thus, we knew that we had a unique form of more crystalline structure within the polylignin.

Polylignin was then subjected to pyrolysis GC/MS to better understand the difference of polylignin between conventional kraft lignin. We found that we had differences and a better understanding of the carbonization and pre carbonization process.

Purification of Polylignin for Crystalline Biographite

The polylignin come from the hybrid organosolv/reactive phase separation process may still comprise a small percentage of other materials within the process that are impurities. From our carbon fiber testing we know that the removal of these impurities further improves the formation of linear crystalline structures that provided higher tensile strength performance. Within this embodiment we include various methods and processes to purify the polylignin material. In one embodiment, the polylignin can be ground into a powder and ran through various wash steps using water or blends of water with additives. In another embodiment the polylignin can ran through a subcritical or supercritical process using water, various alcohols, CO₂, or blends thereof to purify the material.

Purification of the polylignin can be done wherein the solid polylignin material is ground and subjected to various liquid solutions such as water, CO₂, various alcohols or blends thereof in which the purification process can be done at room temperature to elevated temperatures and over a wide range of pressure from 1 atmosphere to supercritical pressure.

Purification can also include purification steps and processes after carbonization or pyrolysis processes using various methods.

Carbonization and Graphitization

Graphite is an allotrope of carbon, its ideal structure composed of graphene layers stacked in a 3D crystalline lattice, with the carbon atoms of each layer nested into the center of the sp2 bonded carbon hexagons of adjacent layers. Graphite commonly displays some degree of turbostratic disorder; that is, graphene sheets that are stacked, but adjacent layers are rotated, translated, or otherwise defective, resulting in imperfections in the registry of the layering, with consequently larger interlayer spacing and lack of c-axis crystalline order. While turbostratic carbon can have a lithium gravimetric (per mass) storage capacity that is higher than that of graphite due to its increased porosity, commercial Li-ion batteries exclusively use graphite with extremely low turbostratic disorder as the anode active material due to its superior discharge potentials, better electrical conductivity, higher volumetric capacity, and lower irreversible losses.

Lump and flake graphite can be used as the raw material for anodes in LIBs due to the two reasons of (a) their high degree of graphitization and (b) crystal characteristics with large flake size. Experiment 8 data shows the comparison of crystal size of synthetic graphite used in lithium-ion batteries as compared to the biographite of the present disclosure showing that in this case the biographite has larger crystal sizes than synthetic graphite. The results show an average crystal size of 290 angstroms which was compared to synthetic crystalline graphite with an average crystal size of 261 angstroms.

Mining and purifying natural graphite results in devastating environmental impacts to the soil, water, and air. Unlike coal, natural graphite is rarely found in veins, instead requiring large-scale benefaction by repeated crushing, milling, and floatation to separate the graphite flakes from the rock they coat (“marks”). Acid leaching, including large-scale use of HF, is performed to remove embedded minerals. High-grade (85-98%) natural flake graphite can be further upgraded to Li-ion battery grade graphite (99.9+%) by intensive purification with a large (70%) material loss.

Graphitization is a transformation process of disordered carbon material ingot three-dimensional graphite by heat treatment, when energy is provided the disordered carbon material, can be graphitized by atomic displacement. Graphitization without catalyst required high temperature up to 3,000° C. Thus, catalytic graphitization was introduced to accelerate the process. The process of graphitization involves limited movement and rearrangement of carbon atoms which undergo reconstructive transformation during the heat treatment process. Formation of graphitic carbon from amorphous carbon precursor may require movement in three dimensions by the pre-graphite matrix to a degree that the precursor substance may pass through a liquid or fluid phase at some point during heat treatment. By undergoing this phase, fluid macromolecules have mobility and are able to move into semi-ordered position in a pre-graphite lattice.

Carbon materials that are able to undergo temporary fluid phase are known as soft carbon. After this first organizational step occur, remaining process at high temperature heat treatment resulting in annealing of carbon into graphite lattice. This step resulting in indexing graphene layers to each other. Intermediate fluid phase is known as “mesophase”. During mesophase basic structure unit form and align into liquid crystal structure that will develop into graphite. In this process carbon precursor, methods and process condition used before heat treatment and during heat treatment affect the degree of graphitization, defect condition, and crystallinity of graphite produced. It will also indirectly affect the synthetic graphite properties such as thermal stability and electrical conductivity.

Carbonization is a process of using high heat in an inert non-oxygen atmosphere to convert carbon containing materials into higher carbon level structures. Crystalline or graphite carbon typically requires higher heat to create this crystalline carbon structures or graphitization. Non-graphite carbon does not transform into graphite at any temperature. Non-graphite carbon is also called amorphous carbon due to its disordered carbon structure. The present disclosure includes a conventional carbonization and graphitization process to create the crystalline biographite from carbon neutrally processed polylignin. Polylignin's novel crystalline structure, hydrophobic nature, and melt flowable characteristics are beneficial to creating various forms of crystalline biographite.

Synthetic graphite utilizes a process called graphitization heating the material to create a highly purified crystalline carbon structure. This is typically done using very high temperatures typically around 2,500° C. Various functional additives can help reduce this temperature still providing a highly ordered crystalline graphite structure from polylignin

Graphite made by the catalyzed pyrolysis of lower cost renewable precursor material represents a new avenue for the development of high-performance negative electrodes for Li-ion batteries.

High performance graphites for commercial Li-ion battery negative electrodes can be derived from the high temperature graphitization (>2800° C.) of soft carbon precursors, such as petroleum pitch. Such graphites are dense, have high gravimetric (˜350 mAh/g) and volumetric (˜720 Ah/L) capacities, low average voltage (˜125 mV vs Li/Li+), low surface area, good rate capability, and pack well during electrode calendering. High temperature processing adds to the cost of artificial graphites. Because of this, the use of lower cost natural graphites is desirable, but such graphites can suffer from reduced rate capability. This is due to the fact that most “renewable” or biobased materials comprise or contain substantial portions of amorphous materials.

Current graphite production is highly energy intensive, creates pollution, generates massive CO₂ and greenhouse gases and creates other environmental problems. Polylignin starts out from a carbon negative position due to the biorefining process for which it is derived. Graphitization is required to create graphite materials and also is highly energy intensive. Although the present disclosure may include standard means and processes to carbonize and graphitization processes, additional processes may be included to lower the temperatures required to create a highly ordered crystalline biographite.

In one aspect, the present disclosure describes the inclusion of another pathway to the formation of biographite introducing metal catalysts during pyrolysis. Catalytic graphitization may lower the graphitization temperature of carbons. An example would be the usage of an iron catalyst. Iron catalysts have the ability to lower the graphitization temperature from 2,400° C. to approximately 1,200° C. and in less time thus lowering the energy and environmental impacts for this process.

Plasma Pyrolysis

In one embodiment, the present disclosure includes various methods for carbonization and pyrolysis of the polylignin into graphite. Plasma pyrolysis provides for one of these optional methods. In plasma pyrolysis, high temperature is produced using plasma torch in oxygen starved environment to destroy plastic waste efficiently and in an eco-friendly manner. Plasma pyrolysis technology is the disintegration of organic compound into gases and non-leachable solid residues in an oxygen-starved environment. Plasma pyrolysis utilizes large fraction of electrons, ions, and excited molecules together with the high energy radiation for decomposing chemicals. In addition, both the physical and chemical reactions occur rapidly in the plasma zone.

Pyrolysis is a method of heating, which decomposes organic materials at temperatures between 400° C. and 650° C., in an environment with limited oxygen. Pyrolysis is normally used to generate energy in the form of heat, electricity, or fuels, but it could be even more beneficial if cold plasma was incorporated into the process, to help recover other chemicals and materials

Various recycling programs using conventional plasma pyrolysis have been used to deal with hazardous waste in the past, but the process occurs at very high temperatures of more than 3,000° C., and therefore requires a complex and energy intensive cooling system. The process for cold plasma pyrolysis that we investigated operates at just 500° C. to 600° C. by combining conventional heating and cold plasma, which means the process requires relatively much less energy.

The cold plasma, which is used to break chemical bonds and initiate and excite reactions, is generated from two electrodes separated by one or two insulating barriers. Cold plasma is unique because it mainly produces hot (highly energetic) electrons—these particles are great for breaking down the chemical bonds of plastics. Electricity for generating the cold plasma could be sourced from renewables, with the chemical products derived from the process used as a form of energy storage: where the energy is kept in a different form to be used later.

The usage of conventional or cold plasma pyrolysis provides for processing using less energy and is included within one embodiment of the present disclosure.

Catalysts

Although iron catalysts are included within the present disclosure for the graphitization process, the present disclosure is not limited to this and includes other metal or metal oxide catalysts. In addition, this can also include the addition of other forms of carbon and silicon, silicon oxides or the like blended with the polylignin procurer prior to the graphitization process.

Metal catalysts during graphitization also may affect or even help the crystalline or ordered carbon structure. Various publications state there are several possible mechanisms have been proposed for conversion of solid carbon resources to graphite material over transition metals through high temperature treatment: Dissolution-precipitation mechanism: the mixture of solid carbon resources and transitional metal is first thermal-treated at high temperature. The solid carbon precursors will decompose and carbonized into disorder carbons like char, while simultaneously metal precursors are reduced to metallic particles or react with carbon to form metal carbides. The metal/carbide particles are uniformly distributed in the disorder carbon matrix. Under the heating treatment temperature, the metal dis-order carbons around metal particles tend to diffuse and dissolve into metal and/or metal carbide. A saturated carbon solubility of metal particles is reached after a certain period of time and under certain temperature. With temperature decrease, the metal saturated with disordered carbon will be supersaturated with carbon. Subsequently, carbon re-precipitates in the form of graphite crystals to the free enthalpy difference between the two forms of carbon, where graphite is the highly ordered carbon with the lowest Gibbs free energy while the disordered carbons have a higher activity.

Polylignin starts as a partially crystalline material thus creates a crystalline carbon structure during carbonization, but given the potential for impurities or some of the polylignin not creating the highest yield of crystalline structure, the addition of various metal catalyst may be included within the present disclosure. This creates a more environmentally friendly, lower carbon intense process. In addition, by lowering the heat energy requirement for graphitization, it is then possible to utilize renewable energy to provide this process.

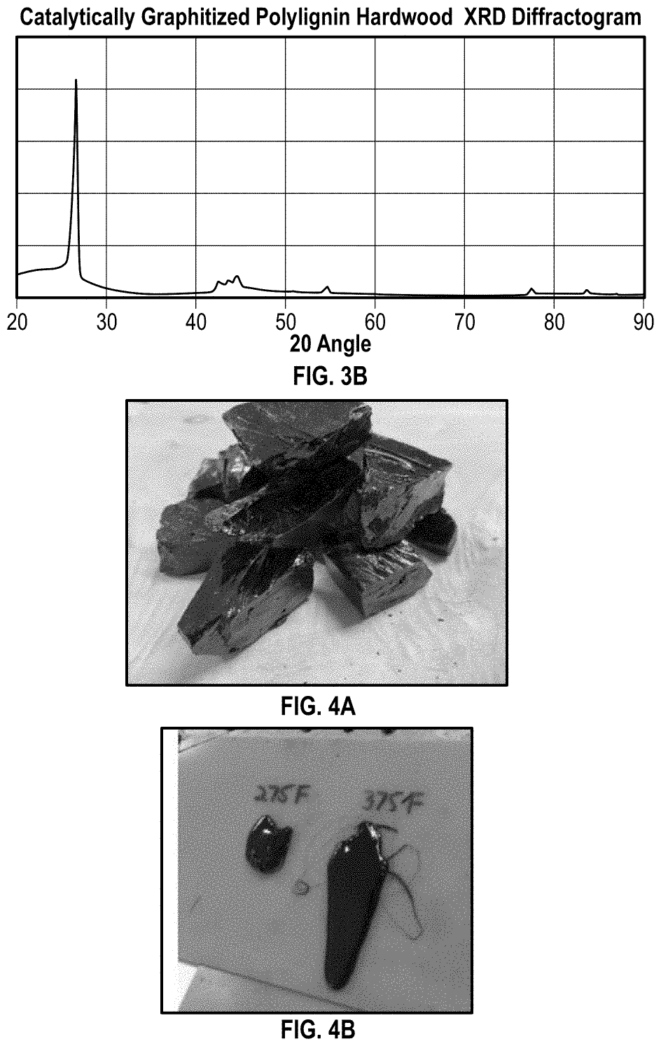

The polylignin was subjected to carbonization or “graphitization” process to measure the yield and understand the crystalline structure. Using X-ray diffraction, we compared synthetic crystalline graphite to the polylignin converted into a crystalline biographite. Again, to our surprise we found that the material was crystalline and actually had larger average crystal size than synthetic in our first tests (see FIG. 3).

For use as anodes in lithium-ion batteries, it is beneficial that the graphite is highly crystalline.

The present disclosure may include standard methods for graphitization using pre oxidation, and other standard methods to create graphite. Additional means to carbonize or provide for a graphitization process are included such as microwave, plasma, or various pre-oxidation/conditioning processes.

One embodiment of the present disclosure includes processes of Plasma Oxidation which improves oxidation speeds up to 5×. In addition, this provides 25% less energy and further improvement of mechanical properties along with other procession advantages. Such processes are called out in U.S. Pat. No. 8,679,592 White, which teaches of a continuous processing method of carbon fiber including microwave generated plasma.

Plasma processing technology is a new approach to the oxidation stage of carbon production in which polymer materials are oxidized (or stabilized) before carbonization. During oxidation, the thermoplastic precursor is converted to a thermoset material that can no longer be melted. Oxidation is the most time-consuming phase of the multistep crystalline carbon conversion process.

Within most processes to create synthetic crystalline graphite or carbon fibers, the process first includes carbonization then graphitization at higher temperatures. The present disclosure may include these standard processes and similar to that of synthetic graphite, the processing temperatures, ramps, and time will have an effect on the final performance and purity of the crystalline biographic.

### Product Benefits

Low Ash

Low Ash content is an advantage for crystalline biographite or graphite of the present disclosure. Impurities are found in mined graphite that is mainly ash presented as silicate mineral in mined graphite. Amorphous graphite minerals and materials typically have higher levels of impurities and holds more ash content which is problematic for lithium-ion battery applications. Polylignin is extremely low in ash content at an amount lower than 0.03%. Thus, the removal of any impurities within the lattice structure helps to attain a highly purified biographite material for higher end technological applications such as lithium-ion batteries.

Thermoset Shapes

The polylignin can be also carbonized and processed by various means of graphitization from formed shapes due to its unique meltable properties, then using slow ramps in temperature to thermoset the material shape, then can be taken to higher temperature for crystalline carbonation.

This provides for the potential to create films, stretched shapes, fibers, and layering on substrates. Given other raw materials for making mined or synthetic graphite all start with solid materials with no ability to melt or melt flow. The polylignin material has the ability to first be molten into various shapes that we believe can further modify the basic carbon or end crystalline structure. This also allows for the unique ability to integrate various other materials to further enhance the biographite for specific applications.

This melt flow ability prior to thermoset carbonization also can allow for various additives. It is known that various corporations and universities are working to integrate silicon and or silicon oxides into various anodes to improved longevity and performance of lithium-ion batteries used in automotive application. By integrates silicon or silicon oxides in a melt flowable state of the polylignin, a more uniform material is formed. During carbonization the polylignin's highly polar nature provides for a good interaction of the two materials to form a hybrid graphite material.

Other materials can also be included that change the crystalline carbon structure including various catalysts, metals, oxides, or blends thereof. The present disclosure may also include the addition of various functional materials that can be melt blended for more uniform dispersion. Such functional materials are, but not limited to metals, metal oxides, iron, metal chlorides, silica, silicon, silicon oxides or blends thereof.

The ability to integrate various functional additives and/or create a shape wherein the entire shape can be carbonized/pyrolyzed can provide pathways to single crystalline structures for various applications. The present disclosure may provide for a crystalline graphite hybrid shape that may further comprise various metals or materials used in lithium-ion batteries as a new form of cathode or anode component.

3D Printing and Shapes

The polylignin's novel characteristics such as acting like a thermoplastic with a melt flow and ability to be re-melted into various shapes provides the present disclosure with a myriad of potential shapes that can be further carbonized into specific products.

The present disclosure may include the ability to 3D print the polylignin or a blend of polylignin with various other carbon fillers, functional fillers, or additives to provide for novel biographite shapes and material characteristics.

Silica Integration

Given the unique melt flowable properties of the crystalline polylignin, the addition of silica may be included within the present disclosure. The blends of silica, silicon, or silicon oxides can also assist in the overall performance of a lithium-ion battery.

Silica can store up to 9 times more energy than graphite itself. Thus, researchers have been working to integrate graphite and silica materials to further enhance the performance of Li-ion batteries. Although this is positive, silicon also expands much more than graphite that can speed up disintegration of battery materials quickly shortening the lifetime of the battery. In addition, too high of silica in an anode can have an adverse effect on the SEI layer formation and stabilization. Thus, various research directions are looking to potential silica additions up to 20% to 30% with graphite.

The present disclosure may include the potential for silicon structured in graphite as a potential process and product based on our novel precursor polylignin material. The inventors believe that the ability to process the melt mixed polylignin and silica prior to graphitization may have the ability to create improved and lower cost silica graphite structures.

The silicon or silica within the present disclosure may also be in the forms of various oxides or silicon metals based on the end applications for electrical storage. This form of additive can be added within the organic phase of the polylignin or can be melt compounded in a conventional twin-screw extruder to provide for a homogenous mixture prior to the carbonization process.

Post-Processing

Crystalline biographite can be used for a wide range of crystalline graphite including drilling materials, friction materials, metallurgy, polymers, non-oxide ceramics, steel production, and more. The main use of high volumes/high purity crystalline graphite is lithium-ion batteries which require further processing of the pure crystalline graphite for usage in batteries.

The crystalline biographite can be processed similar to that of synthetic graphite wherein it is further processed by grinding, classification and spherization processes. Spherization processes use micro granulation to “round” the graphite and remove any flake edges providing a valued smoother surface. Various standard methods can be used which are known by those skilled in the art. New processes for spherization also can be used for this process such as that found in WO 2021040932 Improved micro granulation methods and product particles therefrom, Obrovac discloses of an improved micro granular process with higher yields and improved performance.

Purification of Amorphous Vs. Crystalline Biographite

Although the preferred embodiment is based on highly crystalline biographite, based on the various raw biomass inputs and processing variability, it is possible that the biographite may include small percentage of amorphous graphite. This is similar to that of mined graphite wherein further purification maybe required.

The most abundant natural graphite, occurring at the lowest grades, is amorphous or often called microcrystalline graphite. The origin of amorphous graphite is the result metamorphism of previously existing anthracite coal seams. Here, the term “amorphous” (a non-crystalline material without any long-range order in materials science) denotes the presence of very fine invisible particles in graphite. The grade of microcrystalline graphite varies among 20%-40% in graphite content, and its purity fluctuates from 70% to 85% carbon after being processed. Countries like China and Mexico are known to have large deposits of amorphous graphite

The present disclosure may include purification processes prior to carbonization and graphitization, but also includes optional purification processes after such processes such as hydrometallurgical or pyrometallurgy purification similar to that commonly used in mined graphite purification to obtain a highly crystalline graphite.

The ability to integrate silicon in crystalline graphite is highly desired for improved lithium-ion battery performance and longevity. No other source of mined or synthetic graphite starting raw material has melt flow properties or a melt point, thus the present disclosure may allow for melt mixing various functional additives prior to thermosetting and or carbonization processes.

Magnetic Crystalline Biographite

The present disclosure may also include the ability to add various metals and metal oxides by means of melt mixing prior to carbonization. After carbonization and graphitization, the present disclosure may include the ability to create a magnetic form of crystalline biographite.

Thermoset Processes

The polylignin is melt flowable similar to plastic which can be molded, shaped, extruded and stretched into unlimited shapes. These shapes can then be thermoset by means of a slow heat ramp. In one example polylignin can be subjected to heats around or above 400° F. for a period of hours in which the material will thermoset and lock in a specific structure without losing its shape. This requires a slow ramp of temperature to the thermosetting point as to retain this structure. This also provides for creating crystalline graphite shapes and can have an effect on the crystalline structure itself. Stretching of the material during this process and locking it into a thermoset state, then allows this to be further carbonized creating a tool to changes the carbon structure and also yield large continuous shaped crystalline graphite products.

Evidence of Molecular Change in Polylignin

Polylignin characteristics of fracturing, melt flow, polar, high aliphatic OH groups are unique compared to other lignin's or biobased materials. As shown in FIG. 4A, the polylignin during devolatilization process is polymerized or structure rebuilt to create a crystalline material which has melt characteristics as shown in FIG. 4B and the ability to be re-melt processed just like conventional thermoplastics.

Polylignin BioThermoElastomers (Provisional in Process)

Lactide is a precursor for polylactic acid bioplastics, the most well-known and produced bioplastic. It is a hard, brittle material. Polylignin is also a highly brittle material, but to our surprise when melt blending these materials together, we form a tough biothermoelastomer material similar to that of rubber, because we changed the modular structure of the lignin into a linear crystalline state in which the lactide can provide a backbone creating this elastomeric property.

Thermoplastic, but Ability to be Thermoset

Melt flowable and remeltable, but ability to thermoset with slow temperature ramp can thermoset the material. This is novel because conventional raw materials that are used for synthetic or mined crystalline graphite are not meltable. This now provides ways and pathways to add various functional additives and create shapes. Once created by means of a slow temperature ramp can be thermoset as to lock in the shape or potential stretch within the material or polylignin functional additive blends.

Carbon Fiber Test

Polylignin has been tested for the production of carbon fibers. Normal lignin carbon fibers have a tensile strength of around 400 MPa due to its highly disordered and amorphous state prior to carbonization. Polylignin shows tensile strengths of 700 MPa without purification and over 1,000 with pre purification. In further tests the ability to stretch and thermoset further improved the linear crystalline structure to over 1,200 MPa. Thus, in order to achieve this a linear crystalline structure is required.

Chatoyant Monolignol Acrylate

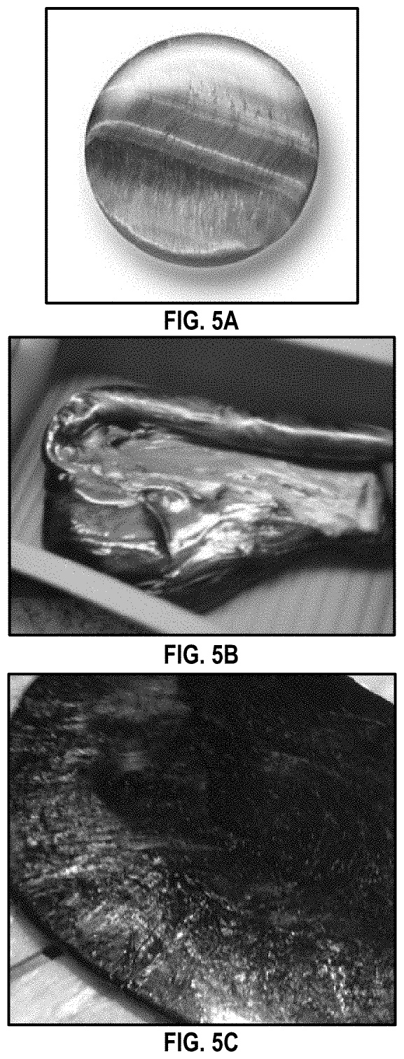

Experiment 4 below teaches of a process to create linear crystalline optical structures from the polylignin in a monolignol acrylate blend and process. FIG. 5A shows a photograph of polished natural tiger eye. When our black crystalline polylignin was melt blended with clear PMMA acrylic, to our surprise, the material turned to a brilliant highly reflective metallic copper color as shown in FIG. 5B. The chatoyant optical properties as shown in FIG. 5C require a continuous micron size crystalline structure within a matrix with a different optical diffraction index in order to achieve this optical effect found in natural tiger eye semi-precious gemstones.

Graphitization Processes

The polylignin has been ran through carbonization and graphitization processes at various temperatures. Initial work also included the blending of oxides, metals, metal oxides, silicon, and carbon as some of the functional additives by melt mixing prior to carbonization.

Further graphitization tests show crystals larger than that tested directly against synthetic graphite.

Carbon Negative Opportunity & Decarbonization

The primary process to create the polylignin precursor is a new form of cellulosic ethanol process wherein carbon negative woody biomass is used as both the feedstock and for electrical/heat energy inputs, thus providing a carbon negative biofuel and carbon negative polylignin co-product with 65-70% carbon content.

In carbonization tests, we see that between 60-75% of the polylignin is vaporized into a syngas during carbonization/pyrolysis as to leave the bio graphite. The syngas release can be converted into a vapor phase fuel that can run a slightly modified diesel engine electrical generator, or the syngas can be further converted into a renewable liquid fuel for usage or sale. This provides a pathway for the process of the present disclosure to provide for a carbon negative biographite.

In one embodiment, carbonization processes can used either plasma or conventional heat methods of carbonization which vaporizes the majority of the polymeric linear polylignin into a syngas.

Given polylignin starts out as a carbon negative material and the potential to use either pyrolysis gas or condensed/converted gas to liquid as a fuel more than sufficient to run the process provides for a pathway to create a carbon negative bio graphite as to help provide a high level of decarbonization for the world.

Pyrolysis GC/MS of the polylignin shows various material peaks at specific temperatures below full graphitization temperatures representing the basic composition of the syngas. Because our polylignin is high carbon and highly consistent, we can provide a consistent vapor phase fuel or feedstock for further conversion into a renewable liquid fuel.

In another embodiment, the present disclosure provides a pathway for carbon negative production of graphite for LIB's and other crystalline graphite applications. Due to the carbon negative process for converting biomass into cellulosic ethanol in which the co-product is a novel form of hydrophobic polymeric linear monolignol material that also has a carbon negative starting point, the process of carbonization creates additional low molecular weight oils and gases which can be used within this process providing for a carbon negative graphite pathway and a decarbonization strategy.

In another embodiment, the polylignin material can be first ground and then purified to remove lower molecular weight materials and impurities by means of washing with water, alcohols or blends thereof. The liquid low molecular weight material removed can be used as a fuel. In addition, the process of the present disclosure may require carbonization and/or pyrolysis which creates various gases that can be used as fuel or condensed into liquid fuels. Thus, we are generating more fuel from this process than we are using to produce the bio graphite, thus the potential for creating a sustainable carbon negative bio graphite as part of a larger decarbonization program.

The present disclosure may provide for this pathway to create a carbon negative bio graphite. In conventional lithium-ion batteries, about 50% of the battery material is graphite from petrochemical processing or mining. From mining it takes approximately 1 ton of ore for about 190 pounds of graphite and to create this uses massive amounts of energy. Thus, the biographite of the present disclosure may provide for an environmentally friendly solution, a pathway for decarbonization, and a lower cost economical process for production of biographite and renewable fuels.

According to various publications, about 80% of the total lifetime emissions from EVs arise from the combination of embodied energy in fabricating the battery and then fabricating electricity to power the vehicle. Thus, it is beneficial to reduce the CO₂ emissions currently created in the production of mined or synthetic graphite from a very high level to a “carbon negative” position. The present disclosure may provide a solution and pathway to achieve this objective.

### Other Applications

Screen Print or Thin Film Graphite by Laser Pyrolysis

Polylignin can be molten to a lower temperature to provide a viscosity similar to screen printing ink which is also used for production of thin film electrical devices. The mass fabrication of electrochemical sensors and biosensors, batteries and fuel cells has benefited enormously from screen-printing technologies. Carbon-based materials, particularly graphite, have become dominant due to their excellent balance between suitable electrochemical properties (chemical inertness, wide accessible potential window, and low background currents, among others) and affordable cost. In spite of the wealth of existing carbon allotropes, screen-printed carbon electrodes (SPCE) are mainly based on graphite1 and amorphous carbon.

Screen-printed carbon electrodes (SPCEs) are enjoying increasing popularity in different electrochemistry areas, from electroanalysis to energy storage and power generation. Highly oriented pyrolytic graphite (HOPG), an ordered form of graphite, displays excellent electrochemical properties. However, its application in screen-printed electrodes has remained elusive

Laser-based process to selectively transform, in ambient conditions, the surface of conventional SPCEs into highly homogeneous HOPG. Energy densities between 6.8 and 7.7 mJ/cm² result in a binder-free, high-purity HOPG surface with very fast electron transfer rates.

Graphite properties provides for high thermal resistance, low friction and self-lubricating, high electrical conductivity, high thermal conductivity, low wettability by liquid metals, resistance to neutron radiation and many other properties and benefits.

Bio Graphite can be used in many of the traditional graphite applications including, but not limited to: refractories; electrodes for electric arc furnaces; molds for casting; lubricants; friction materials; graphite foils; cathode materials for batteries; moderators in nuclear reactors; carbon-carbon composites; steel production; antistatic coatings; anti-flammable applications; molded graphite; pressed graphite; pencils; and electrode materials for fuel cell.

In recent years, a lot of research has been done on proton exchange membrane fuel cells, which convert the chemical energy of the fuel (hydrogen, methanol, etc.) directly into electrical energy. Herein, graphite and other carbon-based materials (carbon black, carbon nanotube and nanofibers, carbon cloth, carbon paper, etc.) are an interesting material for cathode and anode plates. The present disclosure provides for a carbon negative potential solution for this application.

Various modifications and variations can be made to the present disclosure without departing from the spirit or scope of the present disclosure.

From the foregoing, it will be seen that the present disclosure is one well adapted to obtain all the ends and objects herein set forth, together with other advantages which are obvious and which are inherent to the structure.

It will be understood that certain features and sub combinations are of utility and may be employed without reference to other features and sub combinations. This is contemplated by and is within the scope of the claims.

As many possible embodiments may be made of the disclosure described herein without departing from the scope thereof, it is to be understood that all matter herein set forth or shown in the accompanying drawings is to be interpreted as illustrative and not in a limiting sense.

While the foregoing written description enables one of ordinary skill to make and use what is considered presently to be the best mode thereof, those of ordinary skill will understand and appreciate the existence of variations, combinations, and equivalents of the specific exemplary embodiments and methods herein. The disclosed concepts should therefore not be limited by the above-described embodiments and methods, but by all embodiments and methods within the scope and spirit of the incentive concepts as claimed.

### EXAMPLES

Experiment 1

Polylignin was produced using a hybrid organosolv process wherein butanol, biochemicals from hemicellulose of a previous run, water and a blend of hemicellulose derived self-generated hydrophobic biochemicals were blended together so that the blend of biochemical/butanol to water was 50/50. Small wood chips were then introduced and mixed wherein the wood chips were 10% of the total weight of the admixture. The admixture was subjected to heat and pressure in a Par reactor at a temperature of 180 C for 90 minutes. After cooling the material was filtered to remove the cellulose pulp. The remaining liquid mixture is then placed into a vessel in which two separate layers are produced by gravity separation. The top “organic layer” comprises hydrophobic materials including hydrophobic biosolvents and the hydrophobic lignin fragments or monolignols. The aqueous bottom layer comprises water soluble fractions including aqua lignin fragments or monolignols. In the pulp separation, the insoluble lignin is within the pulp matrix and is removed and separate by means of filtering or enzymatic separation.

The hydrophobic organic layer is separated, removed, then heated to evaporate out the hydrophobic biosolvent blend. The remaining material is a polymeric form of fractured lignin fragments or monolignol material became a solid sheet with shinny surface. The sheet was brittle and when broken the edges were very shinny and we observed conchoidal fractures. To our surprise, this looked exactly like obsidian. Thus, we originally thought that this clearly is a different structure compared to all other forms of lignin we had evaluated. This was called polylignin (see FIG. 2).

Experiment 2

We took the material from above and obtained standard kraft lignin from a paper mill placing it into a heating vessel and slowly ramping heat. At temperatures approaching 280° F., we noticed that the material was going through a glass transition and closer to 300° F. started to melt and flow. At these temperatures the kraft lignin simply started to brown. As temperatures ramped closer to 400° F. the polylignin still remained in molten form and we saw a shift in viscosity. The kraft lignin actually started to degrade and burn without any signs of melting

Experiment 3

We took the polylignin and melt blended with various polar plastics and polymers. In one test we melt blended a lactide from NatureWorks Corporation and the polylignin at a ratio of 50/50 and heated to a temperature over 300° F. while mixing. After cooling we were surprised to see that the material was elastic similar to a thermoplastic elastomer and could be remelted many times. This indicated that we were creating a linear structure for this to be achieved.

Experiment 4

We melt blended polylignin with a clear PMMA acrylic also at a 50/50 ratio and heated to over 400° F. The polylignin is a solid black material when molten and the PMMA was clear. To our surprise the material when melt mixed started as black, but then turned into a bright metallic copper color. The material was then hot pressed using a composite press into a flat sheet. After cooling, the material exhibited a very bright copper fiber appearance with a chatoyant optical effect similar to the natural stone “tiger eye” at different angles under a light source. At this point we understood that in order to create this optical functionality, the polylignin created strands of continuous crystalline materials that converted the light in a prismatic effect to create a brilliant metallic copper effect. According to various publications tiger eye semi-precious stones have a chatoyant optical property to create that effect. In gemology, chatoyancy, or chatoyance or cat's eye effect, is an optical reflectance effect seen in certain gemstones. Coined from the French meaning “cat's eye”, chatoyancy arises either from the fibrous structure of a material, as in tiger's eye quartz, or from fibrous crystalline inclusions within the stone.

Chatoyance occurs in stones that contain a large number of very thin parallel inclusions within the stone, known as a “silk.” The light reflects from these inclusions to form a thin band across the surface of the stone. The band of light occurs at right angles to the length of the parallel inclusions. These inclusions can be crystals, hollow tubes, or other linear structures that are present throughout the stone and are usually aligned with a crystallographic axis.

In a chatoyant gemstone, the band of light will move back and forth beneath the surface of the gem as it is turned under a beam of incident light. The band will also move if the position of the light is moved, or the observer moves his head to view the stone from a different angle.

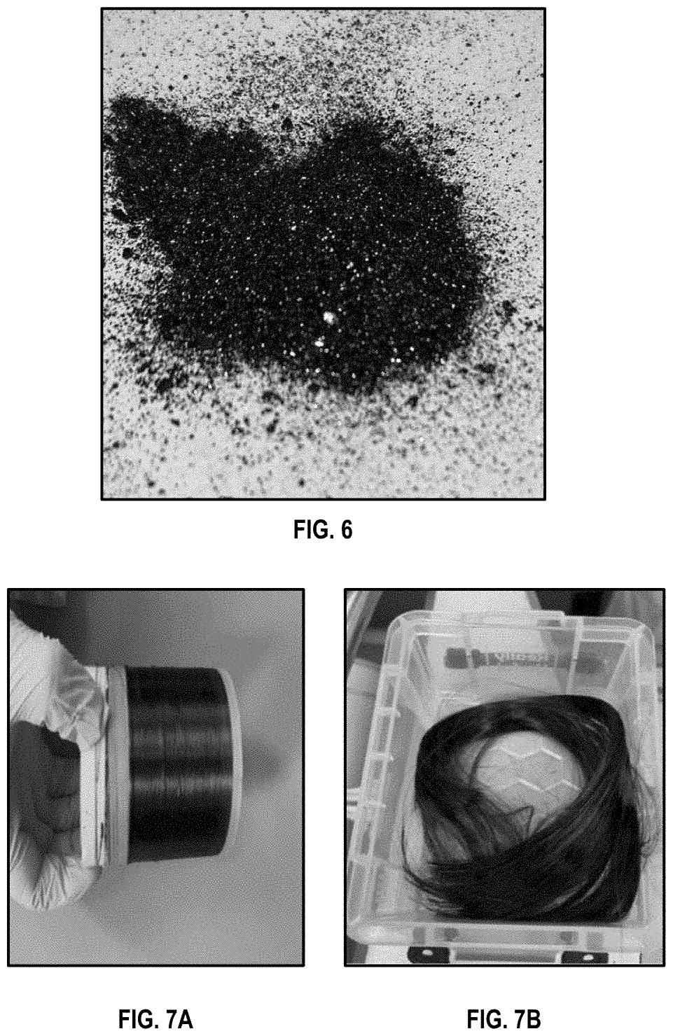

According to gemologist publications, this optical effect has not been created synthetically yet and is seen in “tiger eye” gemstones. This optical property requires a fault-free linear crystalline structure of a fine fiber matrix with extremely small, aligned fibers (see FIG. 6).

Experiment 5

The polylignin was then tested for carbon content in its starting form. Testing showed that the material had a carbon content around 65-70%. The material was then placed in a metallurgical oven with a nitrogen flow blanket and heated to a temperature of 600° C. As shown in FIG. 6, the resulting material was small shiny granular material that when ground had a different shape than grinding the starting polylignin. Carbon testing was then done on the pyrolyzed polylignin and showed an increase in carbon content to over 85%.

Additional pyrolysis tests were done using polylignin with the addition of various iron, iron oxides, zeolite and other metals, metal oxides, silica, and functional additives.

Experiment 6

The polylignin was subjected to pyrolysis GC/MS and did a direct comparison to kraft lignin (see FIG. 4). The results were also surprising that within the polylignin we started to see low molecular weight elements released and also that we saw continued element release at temperatures above 600° C., whereas the kraft lignin stopped all element release at temperatures at around 500° C.

Experiment 7

The polylignin was then melt spun into fine fibers at a temperature of 130° C. for the evaluation of polylignin carbon fiber. The polylignin melt spun with excellent spinnability without the addition of any dissolving agent or solvent due to its thermoplastic properties. The material was then carbonized then pyrolyzed into carbon fiber strands as shown in FIGS. 7A and 7B. The first mechanic tests without any modification showed tensile strengths greater than 700 MPa. A second test was run wherein the polylignin was purified by a simple washing step in which in the same process created tensile strengths of 1,200 MPa. This step removed amorphous impurities and created a more linear crystalline structure shown by the increase in strength. Within this experiment the ash content was also tested for the polylignin that showed a very low ash content below 1% before any purification processing.

Experiment 8

The polylignin was carbonized and graphitized under a nitrogen gas blanket and the resulting material was tested using Xray diffraction. The yield after carbonization and graphitization was 26%. The results show an average crystal size of 290 angstroms which was compared to synthetic crystalline graphite with an average crystal size of 261 angstroms.

Thus, in accordance with the present disclosure, there has been provided methods, processes and systems that fully satisfy the objectives and advantages set forth herein above. Although the present disclosure has been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the present disclosure. Changes may be made in the construction and the operation of the various components, elements, and assemblies described herein, as well as in the steps or the sequence of steps of the methods described herein, without departing from the spirit and scope of the present disclosure. Furthermore, the advantages described above are not necessarily the only advantages of the present disclosure, and it is not necessarily expected that all of the described advantages will be achieved with every embodiment of the presently disclosure.

What is claimed is:

1. A method for making crystalline graphite, the method comprising the steps of:
blending additives with a melt-flowable polylignin to form a blend;
heating the blend to create a melted flowable polylignin with the additives dispersed therein;
cooling the melted flowable polylignin to form a solidified polylignin with dispersed additives;
providing sufficient heat in an inert atmosphere to thermoset and carbonize the solidified polylignin with dispersed additives; and
providing additional heat in an inert atmosphere to graphitize the carbonized polylignin and form a crystalline graphite matrix with uniformly dispersed additives.

2. The method of claim 1, wherein the additives include a functional additive selected from the group consisting of nucleating agents, metal nanoparticles, oxide nanoparticles, carbon, and combinations thereof.

3. The method of claim 2, wherein the additives further include a catalyst.

4. The method of claim 1, wherein the additives include a functional additive selected from the group consisting of silica, silicon metal, and combinations thereof.

5. The method of claim 4, wherein the additives further include a catalyst.

6. The method of claim 1, wherein the additives include a catalyst.

7. The method of claim 6, wherein the catalyst comprises a transition metal catalyst which, when in ionic form, reacts with hydrochloric acid to form a chloride salt.

8. The method of claim 6, wherein the catalyst comprises a transition metal catalyst having a valence of less than three.

9. The method of claim 6, wherein the catalyst comprises a compound selected from the group consisting of iron (III) nitrate, iron oxide, nickel nitrate, chromium nitrate, chromium chloride, manganous acetate, cobaltous nitrate, nickel chloride, and combinations thereof.

10. The method of claim 1, further comprising the step of purifying the melt-flowable polylignin prior to blending the additives.

11. The method of claim 10, wherein the purification step includes washing the melt-flowable polylignin with a solvent selected from the group consisting of water, alcohol, and combinations thereof, and drying the washed melt-flowable polylignin.

12. The method of claim 1, wherein the melted flowable polylignin with the additives dispersed therein is cooled and solidified into a shaped article.

13. The method of claim 1, further comprising the step of grinding the solidified polylignin with dispersed additives prior to the thermoset and carbonizing step.

14. The method of claim 1, further comprising the step of recovering syngas from the thermoset and carbonizing step.

15. The method of claim 14, further comprising conversion of the syngas into a vapor phase fuel or a liquid phase renewable fuel.

16. A crystalline graphite material made using the method of claim 1.

17. A lithium-containing battery comprising a crystalline graphite composite material made using the method of claim 1, wherein the additives include a functional additive selected from the group consisting of silica, silicon metal, and combinations thereof.

18. Crystalline graphite composite material having uniformly dispersed additives.

19. A natural or synthetic graphite application comprising the crystalline graphite composite material of claim 18.

20. A crystalline graphite composite material having uniformly dispersed silica, silicon metal, or both silica and silicon metal.
